(19) United States
(12) Patent Application Publication
(10) Pub. No.: US 2005/0077649 A1
(43) Pub. Date: Apr. 14, 2005

(54) Formable ionomer coated metal sheets

(76) Inventors: Jeffrey Valentage, Royal Oak, MI (US); Domine Joseph Dominic, Humble, TX (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 10/681,652

(22) Filed: Oct. 10, 2003

(51) Int. Cl. B28B 5/00; B32B 15/04

(52) U.S. Cl. 264/241; 428/461; 264/639; 264/245

(57) ABSTRACT

An article and a method for making the same are provided. In one aspect, the article includes a formable metal substrate, and at least one ionomer layer at least partially disposed on the formable metal substrate. In one aspect, the method includes disposing one or more pigmented ionomer layers at least partially on a first surface of a formable metal substrate, disposing one or more transparent ionomer layers at least partially on the one or more pigmented ionomer layers, and shaping the formable metal substrate having the ionomer layers disposed thereon.

### BACKGROUND OF THE INVENTION

1. Field of the Invention

Embodiments of the present invention generally relate to a formable ionomer coated metal sheet having at least one ionomer layer at least partially disposed on a formable metal substrate and a method for making the same.

2. Description of the Related Art

Durable, glossy fascia associated with articles such as automobiles, luggage, appliances, and other durable articles increase both the aesthetic appeal and the utility of these articles. However, it is often difficult, if not impossible, to color external surfaces of these article with traditional paints and common painting techniques. Even when such surfaces are paintable, the paints themselves present an environmental problem. The use of paint increases the presence of volatile organic compounds (“VOC's”) in the atmosphere, water and ground. Also, the presence of paint reduces the recyclability of the articles, as the paint must by stripped using harsh solvents prior to recycling. Thus, there is considerable interest in developing new, paint-free protective and decorative fascia for use on such articles.

Ionomer materials, for example, have gained much attention for coating various substrates. See, for example, U.S. Pat. Nos. 3,264,272, 5,482,766, 4,148,972, 5,543,233, 4,800,130, 4,656,098, 5,206,294, 4,335,175, US Publication Nos. 2002/0114951, 2002/0114965, DE 36 26 809 A; EP 0 721 856; and JP 08269409, JP 2000085062, JP 04052136, WO 01/78981, WO 02/078953, and WO 02/078954. Ionomer coatings are useful for their scratch and abrasion resistance, as well as their toughness and aesthetic appeal. A continued problem, however, is bonding an ionomer sheet or layer to a substrate layer. This is particularly true where the substrate is pre-formed and the ionomer is then secured onto the substrate, which is most often the case in current processes. Typically, automotive parts, such as fenders, hoods, doors, and frames, are made by pre-forming or pre-molding the auto component, preparing the component for painting, and then painting the component with a multi-layer paint system.

The preparation and painting process is time consuming and costly. The preparation steps may include grinding the metal surface, sanding, and polishing. The painting process may include a primer step followed by several layers of paint, each having to dry between applications. Not to mention, the paint room must be free of any particles and contaminants, otherwise they end up in the painted surface. The painting process also generates a considerable amount of waste materials, including toxic and hazardous waste, which must be discarded. Additionally, the pre-formed and pre-painted components make it extremely difficult to secure multi-layered materials such as, for example, laminated ionomer or ionomer layers onto the component surface.

Therefore, what is needed is an article that is aesthetically desirable yet needs no painting, and a method for attaching a pre-pigmented material such as an ionomer to a metal substrate that may be subsequently shaped to form the article.

### SUMMARY OF THE INVENTION

An article and a method for making the same are provided. In one aspect, the article includes a formable metal substrate, and at least one ionomer layer at least partially disposed on the formable metal substrate. In another aspect, the article includes a formable metal substrate, one or more pigmented ionomer layers at least partially disposed on the formable metal substrate, and one or more transparent ionomer layers at least partially disposed on the one or more pigmented ionomer layers.

In one aspect, the method includes disposing one or more pigmented ionomer layers at least partially on a first surface of a formable metal substrate, disposing one or more transparent ionomer layers at least partially on the one or more pigmented ionomer layers, and shaping the formable metal substrate having the ionomer layers disposed thereon.

In another aspect, the method includes forming a laminate comprising two or more ionomer layers, disposing the laminate at least partially on a formable metal substrate, and shaping the formable metal substrate having the laminate disposed thereon.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a perspective view of an automobile 100 having one or more body panels constructed of a formable ionomer coated metal sheet made according to embodiments described herein.

FIG. 2 shows a partial cross section view of a formable ionomer coated metal sheet having one or more ionomer layers at least partially disposed on a metal substrate according to embodiments described herein.

FIG. 3 shows a partial cross section view of a formable ionomer coated metal sheet having one or more ionomer layers and one or more tie-layers at least partially disposed on a metal substrate according to embodiments described herein.

FIG. 4 shows a partial cross section view of a formable ionomer coated metal sheet having one or more barrier layers at least partially disposed on a metal substrate according to embodiments described herein.

FIG. 5 shows a partial cross section view of a formable ionomer coated metal sheet having a laminate of one or more ionomer layers at least partially disposed on a metal substrate according to embodiments described herein.

FIG. 6 shows a schematic diagram of an exemplary thermal lamination apparatus for forming a laminate according to various embodiments described herein.

FIG. 7 shows a partial cross section view of a formable ionomer coated metal sheet having a laminate of one or more ionomer layers and one or more tie-layers at least partially disposed on a metal substrate according to embodiments described herein.

### DETAILED DESCRIPTION

In one aspect, a formable ionomer coated metal sheet is provided for the manufacture of various articles, for example interior and exterior automotive parts, such as bumpers and grills, deck lids, rocker panels, body panels, fenders, doors, hoods, mirror housings, wheel covers, trim, pillar trim, dash boards, seat covers, instrument panels, cup containers and holders, and personal containers and holders, for example. In another aspect, a formable ionomer coated metal sheet is provided for vehicle parts and components for All Terrain Vehicles (ATVs), snowmobiles, boats, jet skis, motorcycles, and any wheeled vehicle, such as fuel tanks, hulls, and other minor components, for example. The term “formable” as used herein refers to a material that is not shaped or formed, but is capable of being shaped or formed into various articles using well known techniques in the art.

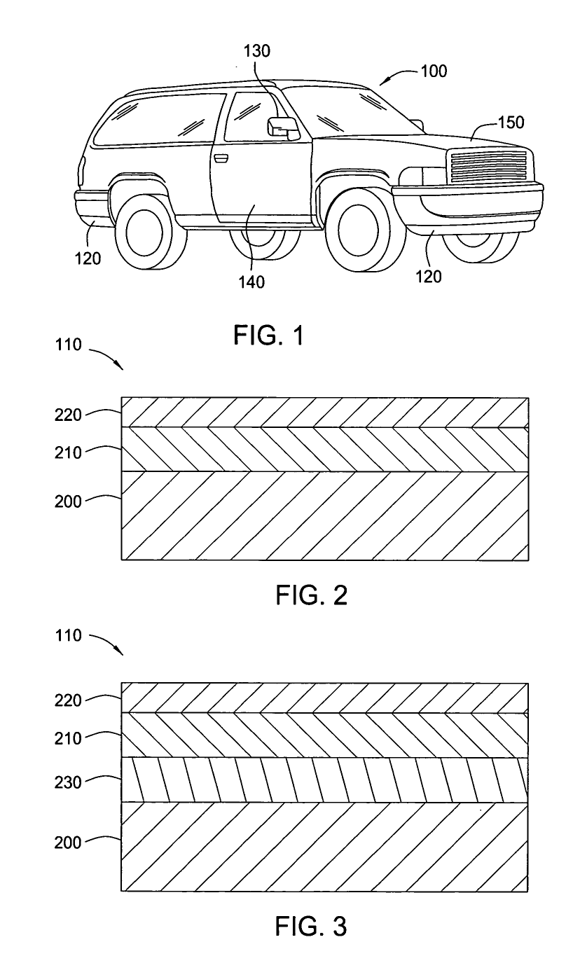

FIG. 1 shows a perspective view of an automobile 100 having one or more body panels constructed of the formable ionomer coated metal sheet described herein. As shown, the automobile includes bumper fascias 120, mirror housings 130, door panels 140, and hoods 150 each disposed on or about a chassis (not shown). Any of these exterior parts as well as interior and other exterior parts not specifically identified in FIG. 1 may be formed from the formable ionomer coated metal sheet according to embodiments described below.

FIG. 2 shows a partial cross section view of a formable ionomer coated metal sheet 110 according to one embodiment herein. The metal sheet 110 includes a pigmented ionomer layer 210 at least partially disposed on a metal substrate 200. The metal sheet 110 also includes a transparent ionomer layer 220 at least partially disposed on the pigmented ionomer layer 210. The ionomer layers 210, 220 provide a durable, scratch resistant surface for the metal substrate 200. The term “at least partially disposed” as used herein refers to any degree of contact, no matter how small, and is not limited to complete coverage or complete deposition of a first material over or on a second material. In other words, at least a portion of a first material overlaps or is in contact with at least a portion of a second material.

The metal substrate 200 may be any metal or metal alloy that provides a sufficiently high stiffness and low coefficient of thermal expansion (CLTE) needed for automotive components. Preferably, the metal substrate 200 is constructed from steel, stainless steel, galvanized steel, aluminum, titanium or any alloy thereof.

In one aspect, the metal substrate 200 may be polished or un-polished. The term “un-polished” as used herein refers to a mill finish. In other words, an un-polished metal substrate has not been subjected to a polishing process or other effort to improve the aesthetics thereof, other than the standard mill finish. Contrastly, the term “polished” as used herein refers to a metal substrate that has been subjected to at least one attempt to improve the aesthetics of the metal substrate, such as removing scratches or other surface blemishes.

In another aspect, the metal substrate 200 may be primed before depositing or attaching the ionomer layers 210 to facilitate the adherence of the ionomer layer 210 to the metal 200. The primer may be used alone or in conjunction with a tie-layer or other adhesive, which are discussed in more detail below with reference to FIG. 3. A suitable primer is any material having sufficient adhesion to the metal substrate which is not adversely affected by thermal aging, or long term exposure to moisture or other chemicals commonly used in or on vehicles, such as brake fluid, gasoline, fuels, washer fluid, and antifreeze, for example. The primer may also be capable of reacting with the acid groups of the ionomer layer 210 and also with the metal 200. For example, a primer containing aminosilane or glycidyl methacryloxysilane may be used. In one embodiment, zinc-rich primers, either organic or inorganic versions, or primers containing zinc and aluminum flakes, can be used to prime steel substrates to reduce corrosion. In another embodiment, epoxy primers can be used. In yet another aspect, the metal substrate 200 may be perforated (not shown) to provide mechanical bonding to the ionomer layers 210, 220 or tie-layers described below. In this aspect, the metal substrate 200 may include one or more perforations, in any pattern, to improve a mechanical bond between the metal substrate 200 and the subsequent layers deposited thereon.

Referring to ionomer layers 210, 220, the pigmented ionomer layer 210 includes one or more colorants (pigments and/or dyes) to provide color. In one embodiment, the pigmented ionomer layer 210 may contain colorants which still allow it to be transparent. In another embodiment, the pigmented ionomer layer 210 may be opaque such that the underlying substrate 200 is blocked or concealed from visual inspection. The transparent ionomer layer 220 may include colorants but is preferably colorless so as to lend a “wet” look of a clear coat to the overall metal sheet 110.

The thickness of the individual ionomer layers 210, 220 varies depending on the application and type of vehicle part or component intended. For example, each layer 210, 220 may have a thickness between about 10 microns to about 6 mm in one embodiment, from about 200 microns to about 6 mm in another embodiment, and from about 250 microns to about 3 microns in yet another embodiment, and from about 500 microns to about 1.55 mm in yet another embodiment. A desirable range being any combination of any upper thickness limit with any lower thickness limit. Typically, the transparent ionomer layer 220 will have a thickness less than the thickness of the pigmented ionomer layer 210.

Each ionomer layer 210, 220 may include a single ionomer or a blend of ionomers. Each ionomer layer 210, 220 may also include a multi-layer stack of ionomers or ionomer blends. The term “layer” as used herein, refers to each of the one or more materials, the same or different, that are secured to one another by any appropriate means such as by an inherent tendency of the materials to adhere to one another, or by inducing the materials to adhere as by a heating, radiative, chemical, or some other appropriate process. The term “layer” is not limited to detectable, discrete materials contacting one another such that a distinct boundary exists between the materials.

Ionomer

Useful ionomers include copolymers of C₂ to C₄ α-olefin derived units (ethylene is herein included as an “α-olefin”) and C₃ to C₆ α,β-ethylenically unsaturated carboxylic acids, and which contain one or more kinds of metallic ions associated with at least 5% of the acidic pendant groups of the polymer. Typical ionomers and methods of production are disclosed in, for example, U.S. Pat. Nos. 3,264,272, 4,911,451, 5,210,138, and 5,929,174; and WO 98/52981, 95/11929, 96/23009, 97/11995, and 97/02317, and described in 2 COMPREHENSIVE POLYMER SCIENCE 755-772 (Colin Booth & Colin Price, ed. Pergamon Press 1989).

The one or more kinds of metal may include mono, di or tri-valent metal ions in the Groups 1 through 13 of the Periodic Table of Elements. Embodiments include the following metal ions: Na⁺, K⁺, Li⁺, Cs⁺, Ag⁺, Hg⁺, Cu⁺, Be²⁺, Mg²⁺, Ca²⁺, Sr²⁺, Ba²⁺, Cu²⁺, Cd²⁺, Hg²⁺, Pb²⁺, Fe²⁺, Co²⁺, Ni²⁺, Zn²⁺, Al²⁺ Sc³⁺, Fe³⁺, Al³⁺ and Yt³⁺. In the various ions mentioned above, Mg²⁺, Na⁺ and Zn²⁺ are more preferred.

The ionomers, either alone or as a blend of two or more ionomers, generally include more than 20 wt % α-olefin derived units in one embodiment by weight of the ionomer, and more than 40 wt % α-olefin derived units in another embodiment, and more than 60 wt % α-olefin derived units in one embodiment, and more than 80 wt % α-olefin derived units in yet another embodiment, and less than 95 wt % α-olefin derived units in another embodiment, and less than 85 wt % α-olefin derived units in another embodiment, and less than 75 wt % α-olefin derived units in yet another embodiment, and from 20 to 95 wt % α-olefin derived units in another embodiment, wherein a desirable range of α-olefin derived units that make up the ionomer is any combination of any upper limit with any lower limit described herein; and from 5 to 25 wt % of α,β-ethylenically unsaturated carboxylic acid derived units in one embodiment, and from 1 to 15 wt % of α,β-ethylenically unsaturated carboxylic acid derived units in another embodiment, and from 8 to 20 wt % of α,β-ethylenically unsaturated carboxylic acid derived units in another embodiment, wherein a desirable embodiment of a useful ionomer may comprise any upper wt % limit and any lower wt % limit of any α,β-ethylenically unsaturated carboxylic acid derived units described herein.

Reaction of the carboxylic acid groups of the ionomer and a metal ion derived from a desirable metal compound (metal oxide, metal hydroxide, metal chloride, etc.) is referred to as “neutralization”. The polymer may be neutralized to form the ionomer to any degree between 10% to 90% based on the total amount of neutralizable carboxylate groups in one embodiment, and from 20% to 80% in another embodiment, and from 40% to 75% in yet another embodiment, and from 5% to 70% in yet another embodiment, provided the necessary scratch and mar resistance is maintained. A desirable level of neutralization may include any upper neutralization % limit and any lower neutralization % limit described herein.

One embodiment of an ionomer can be described as in the following structure (1): 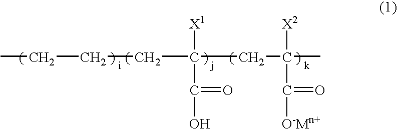
wherein X¹ and X² can be the same or different and are hydrogen or a C₁ to C₆ alkyl, and Mⁿ⁺ is a metal ion or NH₄⁺. Of course, it is understood that when n is 2-4, such as with a divalent metal ion such as Zn²⁺, that charge neutrality for the ionomer is achieved by reaction with a total of n acid groups from either the same polymer chain, or an adjacent polymer chain. The structure (1) is not intended to be construed that the ionomer is a block copolymer or limited to being a block copolymer. The values of i, j, and k are determined by the following relationships (2) and (3):

$$\begin{matrix}\frac{j + k}{i + j + k} = Q & ( 2 ) \\ \frac{k}{j + k} = P & ( 3 )\end{matrix}$$

wherein Q is from 10 to 40% of the polymer units derived from the acidic monomer(s) relative to the total weight of the ionomer in one embodiment, and from 15 to 20% of polymer units derived from the acidic monomer(s) in another embodiment, and P is from 10 to 80% of the acidic groups neutralized with the metallic ions in one embodiment, and from 20 to 70% of the acidic groups neutralized with the metallic ions in another embodiment, and from 20 to 60% in yet another embodiment, and further ranges as stated above. The polymer component i, derived from ethylene in one embodiment can be linear or branched.

Useful ionomers or ionomer blends have a peak melt temperature of greater than 75° C. in one embodiment, and between 75° C. and 200° C. in another embodiment, and between 75° C. and 150° C. in one embodiment, and between 80° C. and 95° C. in another embodiment; and a melt index (MI) of between 0.1 dg/min and 30 dg/min (ASTM D1238, 190/2.16) in one embodiment, from 0.2 to 8 dg/min in one embodiment, from 0.5 to 5 dg/min in another embodiment, and from 0.8 to 2.5 dg/min in yet another embodiment, wherein a desirable range may be any combination of any upper MI limit with any lower MI limit described herein.

The ionomers should provide high scratch and impact resistance to the metal substrate 200. The ionomers or ionomer blends have a 1% secant flexural modulus (ASTM D-790) of greater than 100 MPa in one embodiment, and greater than 300 MPa in another embodiment, and greater than 400 MPa in yet another embodiment, between 150 and 400 MPa in one embodiment, and from 200 to 350 MPa in another embodiment. In still yet another embodiment, the ionomers or blends of ionomers have a 1% secant flexural modulus of greater than 1,000 MPa, such as greater than 2,000 MPa, and greater than 4,000 MPa. Desirable ionomers are ethylene methacrylic acid copolymer ionomers and ethylene acrylic acid copolymers ionomers and the like. Particularly desirable ionomers are those that are sodium or zinc salts of acrylic acid or methacrylic acid copolymers.

Further, certain blends of ionomers based on ethylene acrylic acid copolymer neutralized with divalent and monovalent metal ions such as Zn²⁺ and Na⁺ display a synergistic MI “uplift” as disclosed in, for example, U.S. Pat. Nos. 5,210,138, and 5,929,174 are useful. In one embodiment, each ionomer layer 210, 220 may be a blend of a first ionomer having an MI value of from 0.6 to 1.0 dg/min, and a second ionomer having an MI value of from 2.1 to 3.0 dg/min. The blend of the first and second ionomers includes from 45 wt % to 95 wt % of the first ionomer in one embodiment, and from 55 wt % to 85 wt % of the first ionomer in another embodiment, and from 65 wt % to 80 wt % of the first ionomer in yet another embodiment, and from 72 wt % to 78 wt % of the first ionomer in yet another embodiment, and 75 wt % of the first ionomer in yet another embodiment, wherein a desirable range may include any upper wt % limit and any lower wt % limit described herein. The blends may include two or more ionomers each having different metallation (different metals and/or different % of metallation), different MI values, or a combination of variables.

Other examples of ionomers include, but are not limited to, butadiene-acrylic acid copolymer ionomers, perfluorsulfonate ionomers, perfluorocarboxylate ionomers, telechelic polybutadiene ionomers, sulfonated ethylene-propylene-diene terpolymer ionomers, styrene-acrylic acid copolymer ionomers, sulfonated polystyrene ionomers, sulfonated polypentenamer ionomers, telechelic polyisobutylene sulfonated ionomers, alkyl methacrylate-sulfonate copolymer ionomers, styrene-based polyampholytes ionomers and acid-amine ionomers and the like. Typical examples of ionomers employing salts of carboxylic acid type pendent groups are disclosed in GB 1,011,981; U.S. Pat. Nos. 3,264,272; 3,322,734; 3,338,734; 3,355,319; 3,522,222; and 3,522,223. Typical examples of ionomers employing phosphonate-type pendent groups include those disclosed in U.S. Pat. Nos. 3,094,144; 2,764,563, 3,097,194; and 3,255,130. Typical examples of ionomers employing sulfonate-type pendent groups include those disclosed in U.S. Pat. Nos. 2,714,605; 3,072,618; and 3,205,285. Other useful ionomers are disclosed generally in U.S. Pat. Nos. 5,631,328, 5,631,328, 5,554,698, 4,801,649, 5,320,905, 5,973,046, and 4,569,865.

Ionomers comprising copolymers of ethylene derived units and acrylic acid (AA) derived units are desirable. As shown in Table 1, examples of commercially available ionomers include, but are not limited to, IOTEK ionomers (ExxonMobil Chemical Company, Houston, Tex.), such as IOTEK 8000, a 45% sodium neutralized ethylene-based ionomer of 15 wt % acrylic acid (prior to neutralization), and IOTEK 7030, a 25% zinc neutralized ethylene-based ionomer of 15 wt % acrylic acid, and SURLYN ionomers (DuPont Company, Wilmington, Del.).

In one aspect, the pigmented ionomer layers 210 and the transparent ionomer layer 220 may include a metallic pigment or metal flake blend and be processed in a manner such that the final product has a shiny, metallic-paint look, and changes appearance dependent upon the angle of view (“flop”) or alternatively, processed in a manner such that the final product has a dull look.

The pigmented ionomer layers 210 and the transparent ionomer layer 220 may each contain additives such as antioxidants and other agents. For external uses, it is desirable to add a UV stabilizer such as TINUVEN 791 (CIBA Specialty Chemicals) or UVASIL 2000 HM or LM (Great Lakes Chemicals), both silicon based compositions. Also, for scratch resistance, it is advantageous to add siloxane based compositions such as MB50-001 and/or MB50-321 (Dow Corning Corporation). Effective levels are known in the art and depend on the details of the base polymers, the fabrication mode and the end application. In addition, hydrogenated and/or petroleum hydrocarbon resins and other plasticizers may be used as modifiers.

Other examples of additives include one or more of the following: heat stabilizers or antioxidants, neutralizers, slip agents, antiblock agents, pigments, antifogging agents, antistatic agents, clarifiers, nylon and other polyamides and thermoplastic resins, nucleating agents, ultraviolet absorbers or light stabilizers, fillers, rosins or rosin esters, waxes, additional plasticizers and other additives in conventional amounts.

FIG. 3 shows a partial cross section view of a formable ionomer coated metal sheet 110 according to another embodiment described herein. In this embodiment, the metal sheet 110 may include at least one tie-layer 230 disposed between the metal substrate 200 and the pigmented ionomer layer 210. The tie-layer 230 may have a thickness in the range of from 2.5 microns to 6 mm in one embodiment, and from 25 microns to 650 microns in another embodiment, from 2.5 microns to 400 microns in yet another embodiment, from 2 microns to 100 microns in yet another embodiment, and from 10 microns to 1 mm in yet another embodiment.

Tie-Layer

In one embodiment, the tie layer 230 includes one or more acid polymers. Acid polymers represent a broad class of compounds typically formed by the copolymerization of unsaturated carboxylic acid and at least one α-olefin. Desirably, the carboxylic acid may be formed from a carboxylic acid alone or in combination with an ester. More particularly, the acid polymer may be an acid terpolymer represented by the following structure (4): 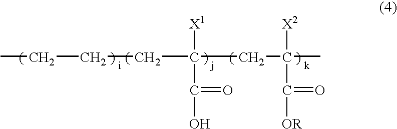
wherein X¹ and X² can be the same or different and are hydrogen or a C₁ to C₆ alkyl, R can be a C₁ to C₁₀ normal alkyl or branched alkyl in one embodiment, and a C₁ to C₄ normal alkyl or branched alkyl in another embodiment, j has a value of from 5 to 15% relative to the acid terpolymer weight, and k has a value of from 5 to 25%, and i has a value of from 65 to 90%. The structure (4) is not intended to be construed that the acid polymer is a block copolymer or limited to being a block copolymer. In one embodiment, the acid polymer may be partially neutralized, creating a so called “soft ionomer,” or partially neutralized acid polymer, wherein the degree of neutralization is from 10% to 75%. The neutralized carboxylic acid groups can be characterized as above for the ionomer. So called soft ionomers are disclosed in, for example, WO 97/02317.

The acid polymer preferably has a melt index (MI) of from 0.1 to 40 dg/min in one embodiment, from 1 to 30 dg/min in another embodiment, from 2 to 20 dg/min in yet another embodiment, and from 2.5 to 10 dg/min in yet another embodiment (ASTM D1238, 190/2.16), a desirable range including a combination of any upper MI limit and any lower MI limit disclosed herein.

In one embodiment, the acid polymer is an acid terpolymer, which includes terpolymers of ethylene derived units, alkyl acrylate derived units, particularly methyl acrylate derived units, and acrylic acid derived units, such as disclosed in U.S. Pat. Nos. 5,397,833, and 5,281,651, and herein referred to as “EAAT”. Other useful acid polymers are disclosed in U.S. Pat. Nos. 4,307,211, and 5,089,332. In one embodiment, the acid polymer is a terpolymer of ethylene derived units, alkyl acrylate derived units, and acrylic acid derived units, wherein the alkyl acrylate derived unit is selected from methyl acrylate, ethyl acrylate, propyl acrylate, butyl acrylate and combinations thereof.

In one embodiment, an ethylene/methyl acrylate/acrylic acid (E/MA/AA) terpolymer comprising an acrylate content of from 4 to 40 wt % based on the weight of the entire polymer is used, and from 5 to 35 wt % is used in another embodiment. The acrylic acid derived unit content is from 1 to 10 wt % in one embodiment, and from 2 to 8 wt % in another embodiment. Described another way, a desirable acid terpolymer is a terpolymer of acrylic acid derived units from 5 wt % to 15 wt % of the polymer, and methyl acrylate derived units from 5 wt % to 25 wt % of the polymer. The remainder of the terpolymer is made up of ethylene derived units.

The E/MA/AA terpolymer may comprise a wide range of melt indexes (MI), generally between 0.1 to 100 dg/min in one embodiment, from 0.1 to 30 dg/min in one embodiment, and from 1 to 10 dg/min in another embodiment, and from 0.5 to 5 dg/min in yet another embodiment (ASTM D1238, 190/2.16), a desirable MI embodiment of the terpolymer comprising any upper MI limit with any lower MI limit described herein.

As shown in Table 1, commercial examples of acid polymers useful in the tie-layer 230 include, but are not limited to, ESCOR AT 310 resin having 6.5 wt % methyl acrylate derived units and 6.5 wt % acrylic acid derived units, and ESCOR AT 320 having 18 wt % methyl acrylate derived units and 6 wt % acrylic acid derived units, both are ethylene acid terpolymers (ExxonMobil Chemical Company, Houston, Tex.). Soft ionomers are commercially available as IOTEK 7510, a 69% zinc neutralized acid terpolymer of 6 wt % acrylic acid and 20 wt % methyl acrylate (prior to neutralization), and IOTEK 7520, a 43% neutralized acid terpolymer of 6 wt % acrylic acid and 20 wt % methyl acrylate, also available from ExxonMobil Chemical Company.

In another embodiment, the tie layer 230 includes one or more epoxy-containing polymers, co-polymers, terpolymers, or a combination thereof. Epoxy-containing polymers may be produced by direct copolymerization of C₂-C₁₀ α-olefins, preferably ethylene and/or propylene, and epoxy-containing monomers such as glycidyl acrylate or glycidyl methacrylate with other ester monomers. Epoxy-containing monomers may be represented by the general formula: 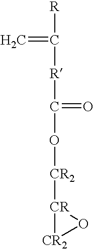
where each R is independently H or a C₁ to C₁₀ hydrocarbon and R′ is independently a bond or a C₁ to C₁₀ hydrocarbon. The polymers of this invention may be made using mixtures of monomers with different R and R′ groups.

Alternatively, epoxy-containing polymers may be made with an ester monomer to from an epoxy-containing terpolymer. The ester monomer may be represented by the general formula: 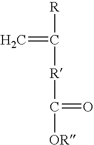
where each R is independently H or a C₁ to C₁₀ hydrocarbon; each R′ is independently a bond or a C₁ to C₁₀ hydrocarbon; and R″ is a C₁ to C₁₀ hydrocarbon. The polymers of this invention may be made using mixtures of monomers with different R, R′ and R″ groups.

Preferred embodiments of epoxy-containing polymers include the copolymers of ethylene and/or propylene with one or more epoxy-containing monomers and one or more ester monomers methyl (meth)acrylate, ethyl (meth)acrylate, propyl (meth)acrylate, or butyl (meth)acrylate.

Epoxy-containing polymers may also be produced by grafting epoxy-containing monomers onto C₂-C₁₀ α-olefins polymers, preferably ethylene and/or propylene polymers and/or copolymers of C₂-C₁₀ α-olefins with polar monomers such as vinyl esters and other ester monomers. These grafted, epoxy-containing polymers may be represented by the general formula:

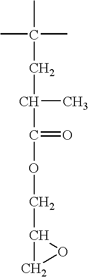

In some embodiments, polymer molecules can be grafted with an epoxy-containing monomer, such as glycidyl methacrylate, in several places along the polymer chain.

Preferable embodiments include glycidyl methacrylate grafted onto polyethylene or a copolymer of ethylene with one or more ester monomers methyl (meth)acrylate, ethyl (meth)acrylate, propyl (meth)acrylate, or butyl (meth)acrylate.

In yet another embodiment, the tie layer 230 includes one or more polymers made with unsaturated diacids, anhydrides of unsaturated diacids, or monoesters of unsaturated diacids. Suitable unsaturated diacids include, but are not limited to, maleic acid, itaconic acid, citraconic acid and 2-pentenedioic acid and their corresponding anhydrides and monoesters. Illustrative examples may be represented by the general formulas: 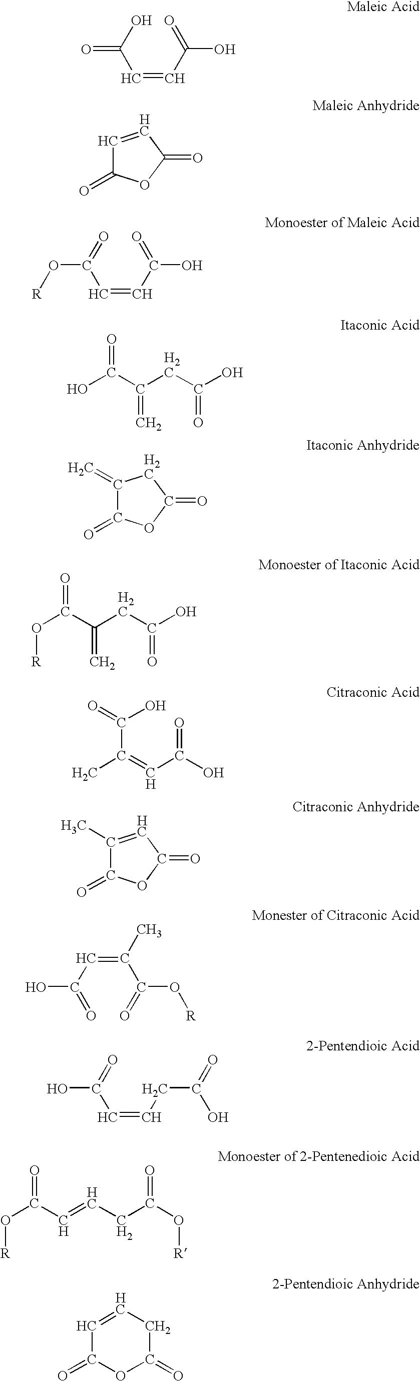
where each R and R′ is independently H or a C₁ to C₁₀ hydrocarbon; wherein each R and R′ are different.

Suitable methods of production of such polymers are well-known in the art, for example, grafting unto the polymer.

In yet another embodiment, the tie-layer 230 may be a blend of the one or more acid polymers, or the one or more epoxy polymers, or the one or more maleated polymers, with one or more other polymers such as α-olefinic polymers or other thermoplastic materials. The term “thermoplastic material” as used herein is defined in POLYMER TECHNOLOGY DICTIONARY 443 (Tony Whelan, ed., Chapman & Hall 1994). Such materials include polyolefins, engineering thermoplastics, thermoplastic rubbers, elastomers, plastics, and other thermoplastics known in the art, and more particularly include materials such as polypropylene homopolymer, copolymers and impact copolymers (ICP), polyethylene homopolymers and copolymers (LLDPE, LDPE, HDPE, etc.), EPDM (ethylene-propylene-diene monomer) or EP (ethylene-propylene rubber), plastomers, acrylonitrile-butadiene-styrene terpolymer, acetal polymer, acrylic polymers, cellulosics, fluoroplastics, nylon and other polyamides, polyamide-imide, polycarbonate, polyester, polyetheretherketone, polyetherimide, polyethylene, polyimide, polyphenylene oxide, polyphenylene sulfide, polypropylene, polystyrene, polysulfone, polyurethane, polyvinyl chloride, and foams of such materials, as well as blends of these materials and other materials such as described in, for example, HANDBOOK OF PLASTICS, ELASTOMERS, AND COMPOSITES 3.18-3.25 (Charles A. Harper, ed., McGraw-Hill Inc. 1992). Suitable thermoplastics or blends of thermoplastics can be made by any suitable means known in the art, and can be made either by physical blending or in-situ reactor-made, for example.

Specifically, the polyolefin may be selected from polyethylene polymers, polyethylene copolymers, polypropylene polymers, polypropylene copolymers, polypropylene impact copolymer and a blend of polypropylene impact copolymer and ethylene plastomer, and mixtures thereof. The polyolefin used in the tie-layer may have a 1% secant flexural modulus of greater than 500 MPa in one embodiment, and a 1% secant flexural modulus of greater than 200 MPa in another embodiment.

In one embodiment, the polyolefin is present in the tie-layer from 30 wt % to 70 wt %, and from 40 wt % to 60 wt % in another embodiment. In yet another embodiment, the tie-layer material comprises a blend of an acid terpolymer and a polypropylene, and the tie-layer material comprises a blend of acid terpolymer and a polyethylene in another embodiment, and the tie-layer material comprises a blend of acid terpolymer, linear low density polyethylene, and high density polyethylene in yet another embodiment.

The tie-layer may also include additives as described above for the ionomer layers, such as pigments, dyes, antioxidants, antiozonants, and other agents to improve its performance. Examples include one or more of the following: heat stabilizers or antioxidants, neutralizers, slip agents, antiblock agents, pigments, antifogging agents, antistatic agents, clarifiers, nucleating agents, ultraviolet absorbers or light stabilizers, fillers, rosins or rosin esters, waxes, plasticizers and other additives in conventional amounts.

TABLE 1
Description And Properties Of Commercially Available Materials.

| | | | | | 1% Secant Flex. |
|---|---|---|---|---|---|
| | | Peak Melt temp. | Melt Index or Melt | | Modulus (MPa) |
| Material | Description | (° C.) | Flow Rate (dg/min) | | [ASTM D-790] |
| IOTEK 3110 | Na salt of ethylene | 94 | 1.3 | (MI) | — |
| (ExxonMobil) | acrylic acid copolymer | | | | |
| IOTEK 7030 | Zn salt of ethylene | 85 | 2.5 | (MI) | 155 |
| (ExxonMobil) | acrylic acid copolymer | | | | |
| IOTEK 7510 | Zn salt of ethylene | 67 | 1.2 | (MI) | 35 |
| (ExxonMobil) | acrylic acid copolymer | | | | |
| IOTEK 7520 | Zn salt of ethylene | 67 | 2.0 | (MI) | 30 |
| (ExxonMobil) | acrylic acid copolymer | | | | |
| IOTEK 8000 | Na salt of ethylene | 83 | 0.8 | (MI) | 320 |
| (ExxonMobil) | acrylic acid copolymer | | | | |
| ESCOR AT 320 | Ethylene acrylic acid | 76 | 5.0 | (MI) | 19 |
| (ExxonMobil) | terpolymer (EAAT) | | | | |
| ESCOR AT 310 | Ethylene acrylic acid | 76 | 6.0 | (MI) | 60 |
| (ExxonMobil) | terpolymer (EAAT) | | | | |
| ESCOR XV4.04 | Ethylene acrylic acid | 78 | 2.5 | (MI) | 27 |
| (ExxonMobil) | terpolymer (EAAT) | | | | |
| PP 8102E3 | Polypropylene impact | 162 | 2.0 | (MFR) | 22930 |
| (ExxonMobil) | copolymer | | | | |
| PP 8224 | Polypropylene impact | 162 | 25 | (MFR) | 1034 |
| (ExxonMobil) | copolymer | | | | |
| PP 7032E2 | Polypropylene impact | 162 | 4 | (MFR) | 980 |
| (ExxonMobil) | copolymer | | | | |
| ESCORENE HD | High Density | 135 | 0.43 | (MI) | 1450 |
| 9856B | polyethylene (HDPE) | | | | |
| (ExxonMobil) | | | | | |
| EXCEED 357C32 | Linear Low Density | 115 | 3.5 | (MI) | — |
| (ExxonMobil) | Polyethylene, | | | | |
| | metallocene catalyzed | | | | |
| | (mLLDPE) | | | | |
| ESCORENE LL | Linear Low Density | 123 | 50 | (MI) | 214 |
| 6201 | Polyethylene | | | | |
| (ExxonMobil) | | | | | |
| ESCORENE HD | High Density | 136 | 8.2 | (MI) | 827 |
| 6908 | Polyethylene (HDPE) | | | | |
| (ExxonMobil) | | | | | |
| MD 353D (DuPont) | PP random copolymer, | — | 450 | (MI) | — |
| | 0.5 to 1 wt % maleic | | | | |
| | anhydride modified | | | | |
| MZ 203D | PP impact | — | 100 | (MI) | — |
| (DuPont) | copolymer, >1 wt % | | | | |
| | maleic anhydride | | | | |
| | modified | | | | |

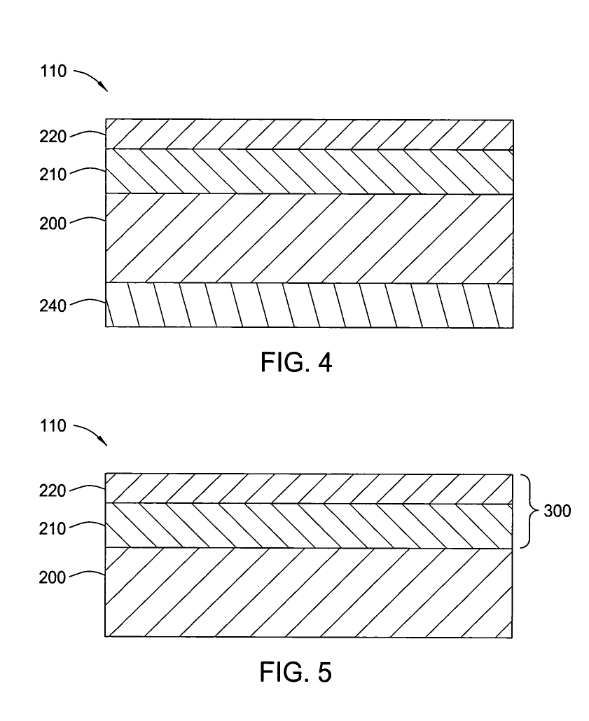

FIG. 4 shows a partial cross section view of a formable ionomer coated metal sheet 110 according to another embodiment described herein. In this embodiment, the metal sheet 110 further includes a barrier layer 240 at least partially disposed on a second surface of the metal substrate 200. The barrier layer 240 may act as a rust proofing and/or sound attenuating layer, and may be made of any material possessing either or both of these properties. For example, the barrier layer 240 may include one or more materials selected from polyethylene, polypropylene, and thermoplastic polyolefins.

The polyethylene, polypropylene, or thermoplastic polyolefins used in the construction of the barrier layer 240 should be a suitable grade for extrusion which exhibits high impact and good barrier properties, and which may be blended with an acid terpolymer or other suitable adhesive material to provide better adhesion to the metal substrate 200. The barrier layer 240 may be extruded onto the metal substrate 200. Alternatively, the barrier layer 240 may be laminated to the metal substrate 200. Nylon, either with or without a compatibilizing polymer to facilitate dispersion, may also be blended in this layer 240 to provide additional barrier properties and to add stiffness.

Laminate Formation

FIG. 5 shows a partial cross section view of a formable ionomer coated metal sheet 110 according to another embodiment described herein. In this embodiment, the ionomer layers 210, 220 are secured to one another to form a laminate 300 prior to arranging on the metal substrate 200. The laminate 300 may include any number of individual layers making up the ionomer layers 210, 220 as described above.

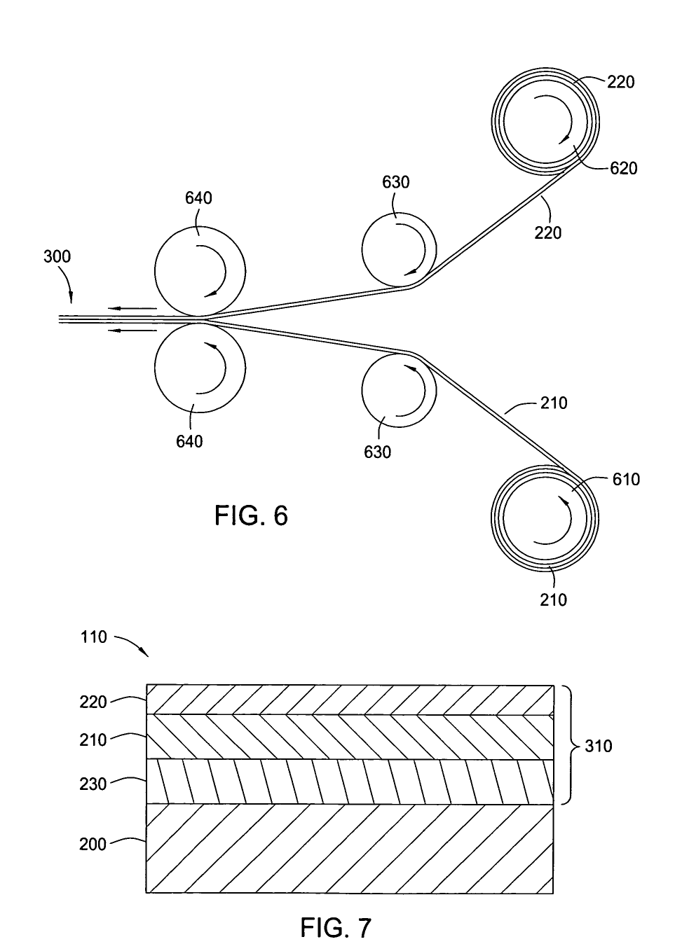

In one embodiment, FIG. 6 shows a schematic diagram of an exemplary thermal lamination apparatus for forming the laminate 300. As shown, the transparent ionomer layer 220 may be unwound from roll 620 and heated (heater not shown) while the pigmented ionomer layer 210 is simultaneously unwound from roll 610 and heated (heater not shown). After passing over guide rollers 630, the ionomer layers 210, 220 meet at the nip formed between heated rollers 640. The surfaces of rollers 640 may be oil-heated and the pressure between the rollers 640 should be sufficient to causes the two layers 210, 220 to mechanically bond together. The resulting laminate 300 is fed away from the rollers 640 and stored as a sheet or on a roll.

In another embodiment, the laminate 300 may be formed using a conventional co-extrusion technique. A conventional co-extrusion process includes first melting each material in an appropriate device and depositing or extruding these molten or semi-molten materials together through a die or dies. The various layers can be combined in the melt stage via appropriate mechanisms known in the art prior to exiting the die, or combined after exiting the die. This is followed by contacting the thus formed multi-layered laminate with a series of chill rolls and sheet conveyer. The cooled laminate is then cut to size or rolled by appropriate means.

Typical co-extrusion process conditions are as follows. The temperature controllers of the extruder(s) used to process the polymeric layers 210, 220 are set at 180° C. to 225° C., yielding a final material melt temperature of 200° C. to 215° C. or higher. Desirably, the polymeric layer 210, 220 material melt temperature is greater than 200° C. The temperature controllers of the extruder(s) used to process the tie-layer 230 are set for 195° C. to 225° C., yielding a final material melt temperature of 210° C. to 230° C. It is desirable that the viscosity of each material to be co-extruded be closely matched to each other for high gloss and color compatibility. This may be accomplished by blending two or more materials having dissimilar MIs, or visbreaking techniques, or other techniques known to those in the art.

In one aspect, an extrusion line is used comprising a die that allows for thermal isolation and/or control of each of the materials being melted to form the multi-layer laminate. The temperature control can be achieved by any suitable means as by insulation and/or thermal cooling and/or heating elements that can be controlled by electricity, steam, oil, or other gases or liquids. Such a co-extrusion apparatus is described in, for example, U.S. Pat. Nos. 5,516,474 and 5,120,484, and references cited therein. The die will have separate flow channels for the two or more materials from which the various layers are formed, and may have a heater or other heat transfer technique by which to heat one or more of the materials to a temperature higher than the melt temperature of those materials going into the die. For example, the die temperature may generally be at from 150° C. to 200° C., while one or more of the material streams that will make up the laminate may be further heated to from 230° C. to 270° C. Heating the pigment-containing layer in this manner is a suitable application. This procedure improves the “flop” of the laminate, in particular when metallic pigments are used.

In any of the embodiments described above, the cooling of the laminate takes place on a chill roll or rolls, and may be cooled any number of ways. In one embodiment, the cooling takes place at a chill roll temperature of from 25° C. to 75° C. In yet another embodiment, the chill rolls are at from 4° C. to 20° C. In the later embodiment, a dull finish is achieved when using a metallic pigment when the laminate is heated in a subsequent forming process.

FIG. 7 shows a partial cross section view of a formable ionomer coated metal sheet 110 according to another embodiment described herein. In this embodiment, the ionomer layers 210, 220 and one or more tie-layers 230 are secured to one another to form a laminate 310 prior to arranging on the metal substrate 200. The laminate 310 may include any number of individual layers making up the ionomer layers 210, 220 and/or tie-layers 230 as described above. In one embodiment, two layers of ionomer 210, 220 may be co-extruded with one layer of tie-layer material 230, wherein the ionomers are Zn²⁺ and Na⁺ salts of ethylene acrylic acid copolymers and the tie-layer material is ethylene acrylic acid terpolymer (or “EAAT”). Another embodiment includes two ionomer layers of zinc and sodium salts of ethylene acrylic acid copolymers and a tie-layer 230 including a polypropylene/acid terpolymer blend such as, for example, a polypropylene impact copolymer present from 10 to 90 wt % in one embodiment, and from 30 to 70 wt % in another embodiment, and from 40 to 60 wt % in yet another embodiment in the blend, and EAAT present from 10 to 90 wt % in one embodiment, from 30 to 70 wt % in another embodiment, and from 40 to 60 wt % in yet another embodiment in the blend.

In yet another example of the laminate 310, two ionomer layers as described above may be present with one layer of tie-layer material, the tie-layer 230 including a blend of high density polyethylene (HDPE) and EAAT. The HDPE may be present in the range from 10 to 90 wt % in one embodiment, from 25 to 75 wt % in another embodiment, and from 35 to 65 wt % in yet another embodiment, while the EAAT is present in the range from 10 to 90 wt % in one embodiment, from 25 to 75 wt % in another embodiment, and from 35 to 65 wt % in yet another embodiment.

In yet another example of the laminate 310, two ionomer layers may be present with one tie-layer material, wherein the tie-layer 230 is a blend of the following: HDPE and linear low density polyethylene (LLDPE) in a ratio of from 75/25 wt % to 85/15 wt %, blended with EAAT, the EAAT present in the tie-layer blend from 10 to 90 wt % in one embodiment, from 25 to 75 wt % in another embodiment, and from 35 to 65 wt % in yet another embodiment.

In yet another example of the laminate 310, two ionomer layers may be present with one tie-layer material, wherein the tie-layer 230 is a blend of the following: linear low density polyethylene blended with EAAT, the EAAT present in the tie-layer blend from 10 to 90 wt % in one embodiment, from 25 to 75 wt % in another embodiment, and from 35 to 65 wt % in yet another embodiment.

In yet another example of the laminate 310, two layers of ionomer as described above may be co-extruded with two layers of tie-layer material. Examples of this tie-layer configuration include one layer of an ethylene acrylic acid terpolymer and another layer of a blend of polypropylene and acid polymer, specifically, a polypropylene impact copolymer present from 10 to 90 wt % in one embodiment, and from 30 to 70 wt % in another embodiment, and from 40 to 60 wt % in yet another embodiment in the blend, and ethylene acrylic acid terpolymer present from 10 to 90 wt % in one embodiment, from 30 to 70 wt % in another embodiment, and from 40 to 60 wt % in yet another embodiment in the blend.

An embodiment of the co-extrusion process operational parameters for producing a laminate with high gloss and high color quality is as follows. The co-extrusion process temperatures for the ionomer layers are from 100° C. to 230° C. in one embodiment, and from 180° C. to 230° C. in another embodiment, with a final material melt temperature (the temperature at which the material is extruded from the die) of from greater than 200° C. in one embodiment, from 200° C. to 220° C. in another embodiment, and from 205° C. to 215° C. in another embodiment. The co-extrusion process temperatures for the tie-layers are from 200° C. to 255° C. in one embodiment, and from 205° C. to 255° C. in another embodiment, with a final material melt temperature of 190° C. to 250° C. in one embodiment, and from 190° C. to 250° C. in yet another embodiment. The die temperature, dual zone top and bottom, is between 195° C. and 235° C. in one embodiment. The chill roll temperatures, typically two to three rolls, are between 10° C. and 71° C.

Desirably, the melt flow rate of each adjacent layer 210, 220, 230 in the laminate 300, 310 is within less than 5 dg/min of each other in one embodiment, and within less than 4 dg/min in another embodiment, and within less than 3 dg/min in yet another embodiment, and within between 0.1 dg/min and 5 dg/min of each other in one embodiment, and within between 0.2 dg/min and 4 dg/min in yet another embodiment, a desirable range being any combination of any upper melt flow rate limit with any lower melt flow rate limit described herein.

Composite Formation

The laminate 300, 310 can be bonded to the metal substrate 200 by any suitable means. In one embodiment, the laminate can be adhesively bonded to the metal substrate using procedures appropriate for the adhesive chosen. In another embodiment, the laminate 300,310 can be bonded to the metal substrate 200 by heating the laminate 300, 310, or the metal substrate 200 or both, and then applying pressure for a period of time to create intimate contact between the laminate 300, 310 and the metal substrate 200 at their interface. In one embodiment, the surface of the laminate 300, 310 which will be bonded to the metal substrate is heated to above 100° C.; in another, to above 150° C.; in yet another, to above 200° C., in yet another, to above 300° C. In these embodiments, the surface of the metal substrate 200 to be bonded to the laminate 300, 310 is heated to above 100° C., or above 150° C. or above 200° C. or above 300° C. as needed to create the desired bond.

In these embodiments, immediately after heating the surfaces, the laminate 300, 310 and the metal substrate 200 are positioned relative to each other to create the area of contact desired for the formable ionomer coated metal sheet 110 being produced. Pressure is applied to the surface of the laminate 300, 310 and the surface of the metal substrate 200 opposite from the surfaces being bonded together. The applied pressure is at least 70 kPa or at least 350 kPa or at least 700 kPa or at least 3.5 MPa or of at least sufficient magnitude to create the desired bond. In some embodiments, the pressure can be programmed, as a function of time, to increase, hold steady or decrease, in any sequence, as needed to optimize the bond. Pressure on the composite can be held for at least 1 second or for at least 5 seconds or for at least 10 seconds or for at least 60 seconds or for at least the amount of time needed to optimize the bond. In these embodiments, the optional barrier layer 240 can be bonded to the second side of the metal substrate 200 simultaneously with bonding the laminate 300, 310 to the first side, using similar surface temperatures. Alternatively, the optional barrier layer 240 can be bonded to the metal substrate 200 in a sequential process, either before or after the laminate 300, 310 is bonded. The temperatures, pressure or pressure program and time used to bond the barrier layer 240 to the metal substrate 200 can be similar to those used to bond the laminate 300, 310 to the metal substrate 200.

A platen press, for example, may be used to develop the pressure needed to create the bonds described above. In most cases, the platens of the press will also be the means by which heat is removed from the formable ionomer coated metal sheet 110 during the bonding process. In some embodiments, the platens can also be heated and used to heat the laminate 300, 310 and metal substrate 200 to the desired temperatures for creating the bond between them, and then subsequently switched to a cooling mode to remove heat from the formable ionomer coated metal sheet 110. Alternatively, the stack comprising the ionomer laminate and the metal substrate can be moved from a heated press for preheating, to a cooling press for removing the heat in the formable ionomer cotated sheet. The optional barrier layer 240 can be bonded to the metal substrate, either simultaneously or sequentially, using the same machine operated under conditions similar to those that would be used to bond the laminate 300,310.

As another example, nip rolls, may be used to form the bond between the laminate 300, 310 and the metal substrate 200 as described above. As needed, the laminate 300, 310, or the metal substrate 200 or both can be heated, as discussed above, prior to being stacked and then passed between one or more sets of nip rolls. Alternatively, while still in a heated condition, the laminate 300, 310 and metal substrate 200 stack can be passed multiple times between one or more sets of nip rolls, in a process that cycles the direction of the sheet, “forward” and “reverse”, with a sufficient number of cycles to create the desired bond. In these embodiments, the optimum gap(s) and/or load setting(s) for the one or more sets of nip rolls can be determined readily by one skilled in the art of calendering. When a cyclic rolling process is used, the gap(s) and/or load setting(s) of the one or more sets of nip rolls can be programmed and changed with each full or half cycle.

Formed Article

A final article made from the formable metal sheet 110 can be formed by either stamping, hydro-forming or other well known techniques in the art. No other secondary painting process is needed to finish the metal sheet 110. Additionally, a protective layer of polyolefin may be applied temporarily to the metal sheet to protect the surfaces of the ionomer layers 210, 220 during the formation of the final article and subsequently removed after the article is formed. For example, a protective stretch wrap or co-extruded layer of polyolefin may be used.

A typical stamping process may include forming the metal sheet 110 into the desired article using mechanical compression as is well known in the art. In one aspect, the stamping process may take place at ambient conditions. In another aspect, a stamping process may be used where the metal sheet 110 is heated to a temperature sufficient to bend or draw the ionomer layers 210, 220 previously disposed on the metal substrate 200. This is often referred to as a “hot stamping” process. In one aspect, the hot stamping process may be performed at any temperature above room temperature. In another aspect, the hot stamping process may be performed at a temperature between about 50 C and about 200 C.

The laminates and articles of the present invention can be used in various applications. They may be used in interior and exterior components of appliances such as clothing or dish washer exteriors, refrigerator door exteriors, refrigerator door interiors, refrigerator liners, refrigerator housings.

The laminates and articles of the present invention can also be applied in construction. Some examples include tubs and showers.

Additionally, the laminates and articles of the present invention have utility for housing on TVs, VCRs, computers, and stereos.

The laminates and articles of the present invention may also be used in a variety of sporting equipment and parts. Illustrative examples include canoe interiors and exteriors, boat covers, jet skis (housings), snowmobiles, and stadium seats.

In other applications, the present invention is applied to exterior or interior parts or components. Illustrative examples include vehicular parts, automotive parts, doors, automotive door panels (exterior), body chassis, body panels, bumpers, deck lids, fenders, hoods, rocker panels, mirror housings, grills, hopper cars, interior trims, pillar trims, cup holders, personal containers, and wheel covers. Applications within this category also include other minor components of any 2, 3, 4 or more wheeled vehicles including farm tractors; lawn and garden tractors; lawn mowers; large trucks; bicycles; toy wagons; parts for All Terrain Vehicles (ATVs); parts for motorcycles, scooters; seat covers; and trims.

The inventive laminates and articles may be used in lawn, yard, and garden applications as well. Some examples are lawn/outdoor furniture, pool covers, outdoor ornaments, and bird houses.

The inventive laminates and articles may also be used in aerospace reentry shields, children's toys, Gamma-radiation resistant applications, luggage, and other applications for coating metals where a dull or glossy and a scratch resistant surface is desirable such as reflective signage and other reflective articles on roadways.

The aforementioned industrial applications may be combined with any of the embodiments described in the SUMMARY as well as any embodiments as claimed.

Claims for other jurisdictions

1. An article for automotive manufacturing, comprising:
   a formable metal substrate;
   one or more pigmented ionomer layers at least partially disposed on the formable metal substrate; and
   one or more transparent ionomer layers at least partially disposed on the one or more pigmented ionomer layers.
2. The article of claim 1, further comprising one or more tie-layers disposed between the one more pigmented ionomer layers and the formable metal substrate.
3. The article of claims 1 or 2, further comprising one or more barrier layers at least partially disposed on a second surface of the formable metal substrate.
4. The article of claim 3, further comprising one or more tie-layers disposed between the second surface of the formable metal substrate and the one or more barrier layers.
5. The article of any of the preceding claims, wherein the one or more pigmented ionomer layers comprise a copolymer of one or more C₂ to C₄ α-olefins and one or more C₃ to C₆ α,β-ethylenically unsaturated carboxylic acids.
6. The article of any of the preceding claims, wherein the one or more transparent ionomer layers comprise a copolymer of one or more C₂ to C₄ α-olefins and one or more C₃ to C₆ α,β-ethylenically unsaturated carboxylic acids.
7. The article of any of the preceding claims, wherein the formable metal substrate is un-polished.
8. The article of any of the preceding claims, wherein the one or more pigmented ionomer layers are opaque.
9. The article of claim 3, wherein the one or more barrier layers comprises polypropylene, polyethylene, thermoplastic materials, or any combination thereof.
10. The article of claims 2 or 4, wherein the one or more tie-layers comprises one or more acid polymers, one or more epoxy polymers, or one or more maleated polymers.
11. The article of any of the preceding claims, wherein the formable metal substrate comprises one or more materials selected from the group consisting of steel, galvanized steel, stainless steel, aluminum, titanium, and alloys thereof.
12. The article of any of the preceding claims, wherein the formable metal substrate is primed.
13. A method for making an automotive manufacturing article, comprising:
   disposing one or more pigmented ionomer layers at least partially on a first surface of a formable metal substrate;
   disposing one or more transparent ionomer layers at least partially on the one or more pigmented ionomer layers; and
   shaping the formable metal substrate having the ionomer layers disposed thereon into an automotive manufacturing article.
14. The method of claim 13, further comprising disposing one or more tie-layers at least partially between the one or more pigmented ionomer layers and the first surface of the formable metal substrate.
15. The method of claims 13 or 14, further comprising disposing one or more barrier layers at least partially on a second surface of the formable metal substrate.
16. The method of claim 15, further comprising disposing one or more tie-layers at least partially between the second surface of the formable metal substrate and the one or more barrier layers.
17. The method of any of the preceding claims, wherein shaping the formable metal substrate having the ionomer layers disposed thereon comprises performing one or more techniques selected from the group consisting of stamping, hydro-forming, or a combination thereof.
18. The method of any of the preceding claims, wherein shaping the formable metal substrate having the ionomer layers disposed thereon comprises stamping at an elevated temperature sufficient to bend or draw the ionomer layers.
19. The method of claim 18, wherein the elevated temperature is between about 50° C. and about 200° C.
20. The method of any of the preceding claims, wherein the formable metal substrate is un-polished.
21. The method of any of the preceding claims, wherein at least one of the one or more pigmented ionomer layers is opaque.
22. The method of any of the preceding claims, wherein the formable metal substrate comprises one or more materials selected from the group consisting of steel, galvanized steel, stainless steel, aluminum, titanium, and alloys thereof.
23. The method of any of the preceding claims, further comprising priming the first surface of the formable metal substrate prior to disposing the one or more pigmented ionomer layers.
24. The method of claim 14, further comprising priming the first surface of the formable metal substrate prior to disposing the one or more tie-layers at least partially between the one or more pigmented ionomer layers and the first surface of the formable metal substrate.
25. The method of claim 15, further comprising priming the second surface of the formable metal substrate prior to disposing the one or more barrier layers at least partially on the second surface of the formable metal substrate.
26. The method of claim 16, further comprising priming the second surface of the formable metal substrate prior to disposing the one or more tie-layers at least partially between the second surface of the formable metal substrate and the one or more barrier layers.

While the present invention has been described and illustrated by reference to particular embodiments, those of ordinary skill in the art will appreciate that the invention lends itself to many different variations not illustrated herein. For these reasons, then, reference should be made solely to the appended claims for purposes of determining the true scope of the present invention.

Terms that are or may be trademarked in some jurisdictions are used in the description. These terms are written in all capital letters, and is understood to recognize such trademarks. For brevity, markings such as “™” or “®” have not been used.

All priority documents are herein fully incorporated by reference for all jurisdictions in which such incorporation is permitted to the extent such disclosure is not inconsistent with the invention and its embodiments described herein. Further, all documents cited herein, including testing procedures, publications, patents, journal articles, etc., are herein fully incorporated by reference for all jurisdictions in which such incorporation is permitted.

1. (canceled)

2. (canceled)

3. (canceled)

4. (canceled)

5. (canceled)

6. (canceled)

7. (canceled)

8. (canceled)

9. An article comprising:
a formable metal substrate;
one or more pigmented ionomer layers at least partially disposed on the formable metal substrate; and
one or more transparent ionomer layers at least partially disposed on the one or more pigmented ionomer layers.

10. The article of claim 9, wherein the one or more pigmented ionomer layers comprise a copolymer of one or more C₂ to C₄ α-olefins and one or more C₃ to C₆ α,β-ethylenically unsaturated carboxylic acids.

11. The article of claim 9, wherein the one or more transparent ionomer layers comprises a copolymer of one or more C₂ to C₄ α-olefins and one or more C₃ to C₆ α,β-ethylenically unsaturated carboxylic acids.

12. The article of claim 9, wherein the formable metal substrate is un-polished.

13. The article of claim 9, further comprising one or more tie-layers disposed between the one or more pigmented ionomer layers and the formable metal substrate.

14. The article of claim 9, further comprising one or more barrier layers at least partially disposed on a second surface of the formable metal substrate.

15. The article of claim 14, further comprising one or more tie-layers disposed between the second surface of the formable metal substrate and the one or more barrier layers.

16. The article of claim 9, wherein the one or more pigmented ionomer layers are opaque.

17. The article of claim 14, wherein the one or more barrier layers comprises polypropylene, polyethylene, thermoplastic materials, or any combination thereof.

18. The article of claim 13, wherein the one or more tie-layers comprises one ore more acid polymers, one or more epoxy polymers, one or more maleated polymers, or a combination thereof.

19. The article of claim 9, wherein the formable metal substrate comprises one or more materials selected from the group consisting of steel, galvanized steel, stainless steel, aluminum titanium, and alloys thereof.

20. The article of claim 9, wherein the formable metal substrate is primed.

21. A method comprising:
disposing one or more pigmented ionomer layers at least partially on a first surface of a formable metal substrate;
disposing one or more transparent ionomer layers at least partially on the one or more pigmented ionomer layers; and
shaping the formable metal substrate having the ionomer layers disposed thereon.

22. The method of claim 21, wherein shaping the formable metal substrate having the ionomer layers disposed thereon comprises performing one or more techniques selected from the group consisting of stamping, hydro-forming, or a combination thereof.

23. The method of claim 21, wherein shaping the formable metal substrate having the ionomer layers disposed thereon comprises stamping at an elevated temperature sufficient to bend or draw the ionomer layers.

24. The method of claim 23, wherein the elevated temperature is between about 50 C and about 200 C.

25. The method of claim 21, wherein the formable metal substrate is un-polished.

26. The method of claim 21, further comprising disposing one or more tie-layers at least partially between the one or more pigmented ionomer layers and the first surface of the formable metal substrate.

27. The method of claim 21, further comprising disposing one or more barrier layers at least partially on a second surface of the formable metal substrate.

28. The method of claim 27, further comprising disposing one or more tie-layers at least partially between the second surface of the formable metal substrate and the one or more barrier layers.

29. The method of claim 21, wherein at least one of the one or more pigmented ionomer layers is opaque.

30. The method of claim 21, wherein the formable metal substrate comprises one or more materials selected from the group consisting of steel, galvanized steel, stainless steel, aluminum, titanium, and alloys thereof.

31. The method of claim 21, further comprising priming the first surface of the formable metal substrate prior to disposing the one or more pigmented ionomer layers.

32. The method of claim 26, further comprising priming the first surface of the formable metal substrate prior to disposing the one or more tie-layers.

33. The method of claim 28, further comprising priming the second surface of the formable metal substrate prior to disposing the one or more tie-layers at least partially between the second surface of the formable metal substrate and the one or more barrier layers.

34. The method of claim 27, further comprising priming the second surface of the formable metal substrate prior to disposing the one or more barrier layers.

35. A method comprising:
forming a laminate comprising two or more ionomer layers;
disposing the laminate at least partially on a formable metal substrate; and
shaping the formable metal substrate having the laminate disposed thereon.

36. The method of claim 35, wherein forming the laminate comprises co-extruding the two or more ionomer layers.

37. The method of claim 35, wherein the laminate further comprises one or more tie-layers.

38. The method of claim 35, wherein the two or more ionomer layers comprise at least one pigmented ionomer layer and at least one transparent ionomer layer.

39. The method of claim 35, wherein the two or more ionomer layers comprise at least one pigmented ionomer layer that is opaque.

40. The method of claim 35, wherein shaping the formable metal substrate having the laminate disposed thereon comprises performing one or more techniques selected from the group consisting of stamping, hydro-forming, or a combination thereof.

41. The method of claim 35, wherein shaping the formable metal substrate having the laminate disposed thereon comprises stamping at an elevated temperature sufficient to bend or draw the laminate.

42. The method of claim 41, wherein the elevated temperature is between about 50 C and about 200 C.

43. The method of claim 35, wherein the formable metal substrate is un-polished.

44. The method of claim 35, further comprising disposing one or more tie-layers at least partially between the laminate and the first surface of the formable metal substrate.

45. The method of claim 35, further comprising disposing one or more barrier layers at least partially on a second surface of the formable metal substrate.

46. The method of claim 45, further comprising disposing one or more tie-layers at least partially between the second surface of the formable metal substrate and the one or more barrier layers.

47. The method of claim 35, wherein the formable metal substrate comprises one or more materials selected from the group consisting of steel, galvanized steel, stainless steel, aluminum, titanium, and alloys thereof.

48. The method of claim 35, further comprising priming the formable metal substrate prior to disposing the laminate.

49. The method of claim 44, further comprising priming the formable metal substrate prior to disposing the one or more tie-layers.

50. The method of claim 45, further comprising priming the formable metal substrate prior to disposing the one or more barrier layers.

51. The method of claim 46, further comprising priming the formable metal substrate prior to disposing the one or more tie-layers.
